(19) United States
(12) Patent Application Publication
(10) Pub. No.: US 2019/0285744 A1
(43) Pub. Date: Sep. 19, 2019

(54) ULTRASOUND RANGING DEVICE, SYSTEM AND METHOD

(71) Applicant: Quanta Computer Inc., Taoyuan City (TW)

(72) Inventor: Chien-Hung LIU, Taoyuan City (TW)

(21) Appl. No.: 16/126,293

(22) Filed: Sep. 10, 2018

(30) Foreign Application Priority Data
Mar. 19, 2018 (TW) 107109248

(51) Int. Cl. G01S 15/10; G06F 7/58

(52) U.S. Cl. CPC G01S 15/105; G06F 7/588

(57) ABSTRACT

An ultrasound ranging device is provided. The ultrasound ranging device includes an ultrasound transmitter, an ultrasound receiver, a random number generator and a processor. The ultrasound transmitter transmits an ultrasonic signal. The ultrasound receiver receives a reflected signal which is generated when the ultrasonic signal meets an obstacle. The random number generator generates a random number. The processor is coupled to the random number generator to obtain the random number and according to the random number, the processor determines the delay time for the ultrasound transmitter transmitting the ultrasonic signal. After the delay time, the ultrasound transmitter transmits the ultrasonic signal to perform ultrasound ranging.

### CROSS REFERENCE TO RELATED APPLICATIONS

This application claims priority of TW Patent Application No. 107109248 filed on Mar. 19, 2018, the entirety of which is incorporated by reference herein.

### BACKGROUND OF THE INVENTION

### Field of the Invention

The invention generally relates to ultrasound ranging technology, and more particularly, to ultrasound ranging technology for determining a time duration for ultrasound ranging according to random numbers generated by a random number generator.

### Description of the Related Art

As technology progresses, ultrasound is widely applied in different fields, such as distance measurement, medicine, fish detection, vehicle parking sensors, and so on.

In ultrasound ranging, an ultrasound ranging device is used to transmit an ultrasonic signal and to receive a reflected signal which is generated when the ultrasonic signal meets an obstacle, and this reflected signal can be used to help calculate the distance to the obstacle. However, when a plurality of ultrasound ranging devices perform ultrasound ranging at the same time, such as when a plurality of unmanned aerial vehicles need to perform an aerial exhibition together, the ultrasound ranging devices may interfere with each other, and as a result, a collision may occur.

### BRIEF SUMMARY OF THE INVENTION

An ultrasound ranging device, system and method are provided to overcome the problems mentioned above.

An embodiment of the invention provides an ultrasound ranging device. The ultrasound ranging device comprises an ultrasound transmitter, an ultrasound receiver, a random number generator and a processor. The ultrasound transmitter transmits an ultrasonic signal. The ultrasound receiver receives a reflected signal which is generated when the ultrasonic signal meets an obstacle. The random number generator generates a random number. The processor is coupled to the random number generator to obtain the random number and according to the random number, the processor determines the delay time for the ultrasound transmitter transmitting the ultrasonic signal. After the delay time, the ultrasound transmitter transmits the ultrasonic signal to perform ultrasound ranging.

An embodiment of the invention provides an electronic device. The electronic device comprises a control device and an ultrasound ranging device. The control device generates a control signal. The ultrasound ranging device is coupled to the control device. The ultrasound ranging device comprises an ultrasound transmitter, an ultrasound receiver, a random number generator and a processor. The ultrasound transmitter transmits an ultrasonic signal. The ultrasound receiver receives a reflected signal which is generated when the ultrasonic signal meets an obstacle. The random number generator generates a random number. The processor is coupled to the random number generator to obtain the random number and according to the random number, the processor determines the delay time for the ultrasound transmitter transmitting the ultrasonic signal. After the delay time, the ultrasound transmitter transmits the ultrasonic signal to perform ultrasound ranging.

An embodiment of the invention provides an ultrasound ranging method. The ultrasound ranging method is applied to an ultrasound ranging device. The ultrasound ranging method comprises the steps of receiving a random number from a random number generator; determining the delay time for an ultrasound transmitter of the ultrasound ranging device transmitting an ultrasonic signal; and after the delay time, transmitting the ultrasonic signal to perform ultrasound ranging.

Other aspects and features of the invention will become apparent to those with ordinary skill in the art upon review of the following descriptions of specific embodiments of methods and devices.

### BRIEF DESCRIPTION OF THE DRAWINGS

The invention will become more fully understood by referring to the following detailed description with reference to the accompanying drawings, wherein:

FIG. 1 is a block diagram illustrating an electronic device 100 according to an embodiment of the invention;

FIG. 2A is a block diagram illustrating an ultrasound ranging device 110 according to an embodiment of the invention;

FIG. 2B is a schematic diagram illustrating an ultrasound ranging device 110 according to an embodiment of the invention;

FIG. 3 is a schematic diagram illustrating the time interval according to an embodiment of the invention;

FIG. 4A is a circuit diagram illustrating an ultrasound ranging device 110 according to an embodiment of the invention;

FIG. 4B is a circuit diagram illustrating a control device 120 according to an embodiment of the invention; and

FIG. 5 is a flow chart 500 illustrating an ultrasound ranging method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

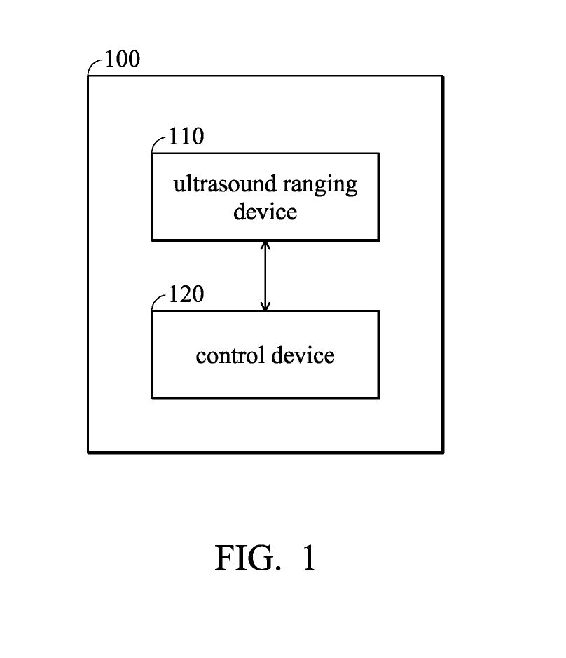

FIG. 1 is a block diagram illustrating an electronic device 100 according to an embodiment of the invention. According to the embodiments of the invention, the electronic device 100 may be an unmanned aerial vehicle, a robot, and so on. As shown in FIG. 1. The electronic device 100 may comprise an ultrasound ranging device 110 and a control device 120. Note that, FIG. 1 presents a simplified block diagram for illustrating the embodiment of the invention conveniently. However, the invention should not be limited to what is shown in FIG. 1. The electronic device 100 may comprise other elements.

According to an embodiment of the invention, the ultrasound ranging device 110 may receive the control signals from the control device 120, and perform the ultrasound ranging according to the control signals from the control device 120.

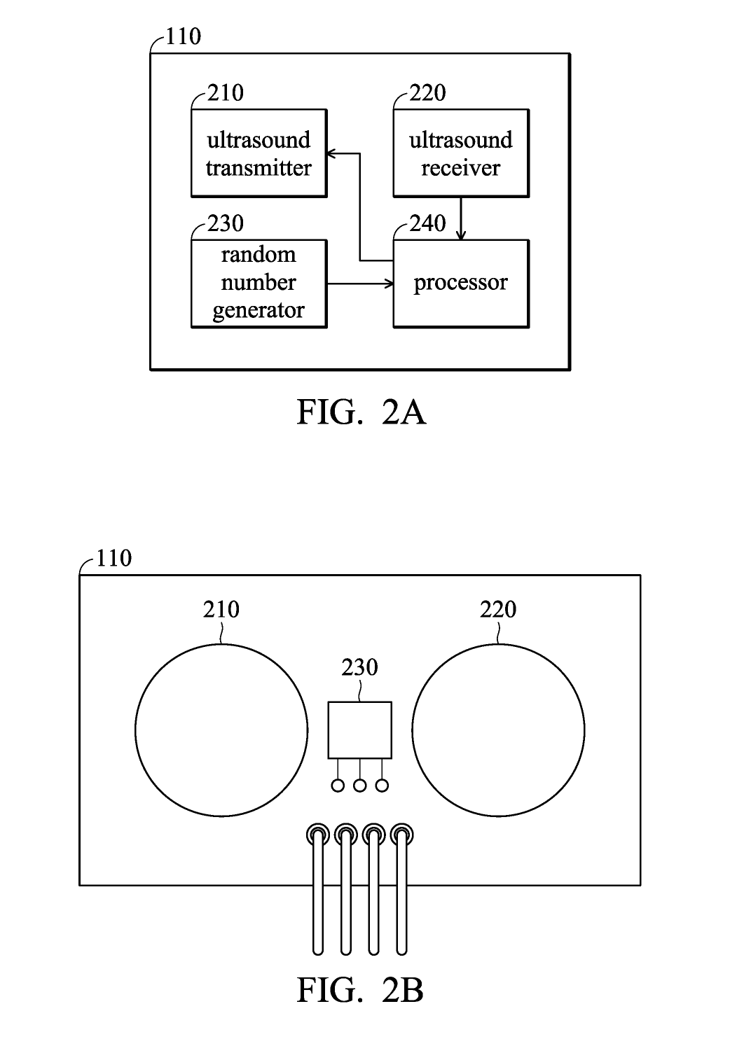

FIG. 2A is a block diagram illustrating an ultrasound ranging device 110 according to an embodiment of the invention. As shown in FIG. 2A, the ultrasound ranging device 110 may comprise an ultrasound transmitter 210, an ultrasound receiver 220, a random number generator 230 and a processor 240. Note that FIG. 2A presents a simplified block diagram for conveniently illustrating the embodiment of the invention. However, the invention should not be limited to what is shown in FIG. 2A. FIG. 2B is a schematic diagram illustrating an ultrasound ranging device 110 according to an embodiment of the invention.

According to an embodiment of the invention, the ultrasound transmitter 210 may transmit an ultrasonic signal, and the ultrasound receiver 220 may receive a reflected signal which is generated (reflected) when the ultrasonic signal transmitted by the ultrasound transmitter 210 meets the obstacle.

According to an embodiment of the invention, the random number generator 230 may generate a random number Rn. According to an embodiment of the invention, the random number Rn is an integer which comprises at least three digits.

According to an embodiment of the invention, the processor 240 may be a microcontroller unit (MCU). When the ultrasound ranging device 110 is enabled, the processor 240 may start to perform initial setting and determine whether receiving the control signal from the control device 120.

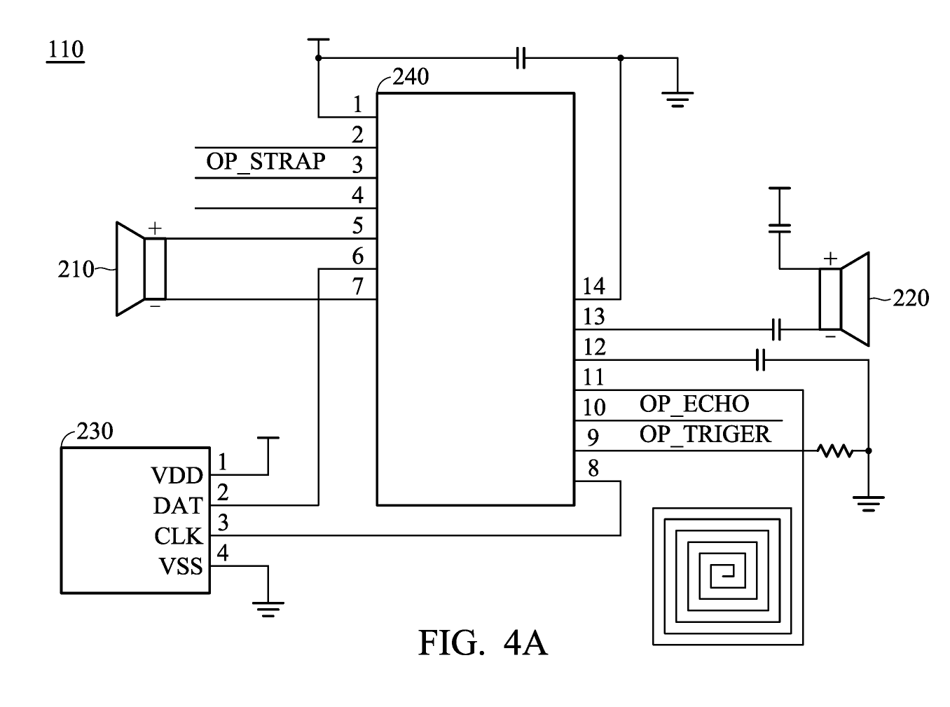

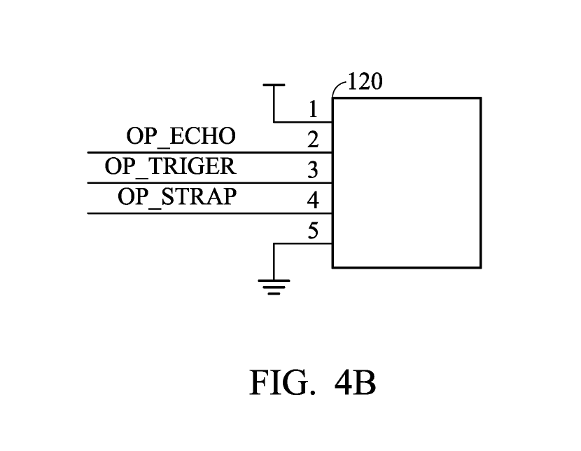

According to an embodiment of the invention, after the processor 240 receives the control signal from the control device 120, the processor 240 may obtain a random number Rn from the random number generator 230 and obtain a pin value Ad from an analog-to-digital (ADC) pin (e.g. the pin 11 shown in FIG. 4B) of the processor 240. Then, the processor 240 may perform a calculation according to the random number Rn and the pin value Ad to generate a delay time Ur. According to an embodiment of the invention, the calculation performed by the processor 240 may be an add operation (e.g. Ur=Rn+Ad), but the invention should not be limited thereto. For example, if the random number Rn obtained by the processor 240 is 020 and the pin value Ad obtained by the processor 240 is 180, the processor 240 may calculate that the delay time Ur is 200 millisecond (ms). According to the embodiments of the invention, the ADC pin may be a default pin of the processor 240. The ADC pin is connected to the circuit board of the ultrasound ranging device 110 to generate a random pin value Ad.

Therefore, when the processor 240 receives the control signal from the control device 120 to perform the ultrasound ranging, the processor 240 may indicate the ultrasound transmitter 210 to transmit the ultrasonic signal to perform the ultrasound ranging after the delay time Ur is expired.

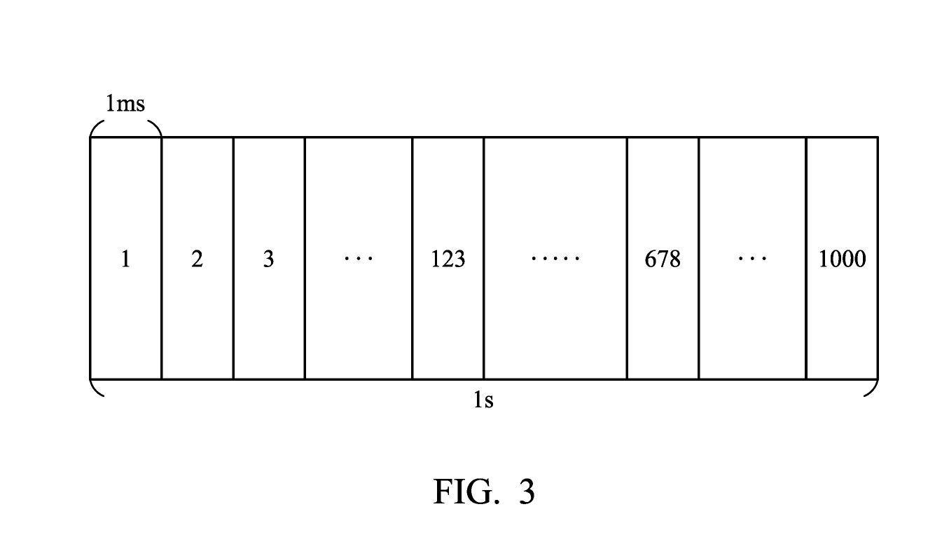

FIG. 3 is a schematic diagram illustrating the time interval according to an embodiment of the invention. As shown in FIG. 3, if 1 millisecond (ms) is used as the unit of the time interval, 1 second can be divided into 1000 time intervals. For example, if the delay time Ur generated by the processor 240 is 678, the ultrasound transmitter 210 may transmit the ultrasonic signal to perform the ultrasound ranging after waiting for 678 ms. That is to say, the ultrasound transmitter 210 may transmit the ultrasonic signal to perform the ultrasound ranging in the time interval of 678 ms. If the delay time Ur generated by the processor 240 is 123, the ultrasound transmitter 210 may transmit the ultrasonic signal to perform the ultrasound ranging after waiting for 123 ms. That is to say, the ultrasound transmitter 210 may transmit the ultrasonic signal to perform the ultrasound ranging in the time interval of 123 ms.

When the ultrasound ranging is performed, the ultrasound transmitter 210 may transmit an ultrasonic signal at a fixed frequency (e.g. an ultrasonic signal 10101010 of 40 KHz, but the invention should not be limited thereto) to perform the ultrasound ranging in the corresponding time duration. When the ultrasound receiver 220 receives a reflected signal which is generated when the ultrasonic signal transmitted by the ultrasound transmitter 210 meets the obstacle, the ultrasound receiver 220 may transform the reflected signal to the voltage signal, and then transmit the voltage signal to the processor 240. The processor 240 may calculate distance based on the roundtrip time of the ultrasonic signal (i.e. (roundtrip time of the ultrasonic signal*sound velocity)/2), and transmit a response signal containing information about the distance to the control device 120.

According to an embodiment of the invention, after the ultrasound transmitter 210 transmits the ultrasonic signal, the processor 240 may start to count time. If the ultrasound receiver 220 does not receive the reflected signal within a default time (e.g. 5 ms), the processor 240 may restart to await a new control signal transmitted by the control device 120.

According to an embodiment of the invention, after the processor 240 receives the reflected signal (which is transformed into a voltage signal by the ultrasound receiver 220) from the ultrasound receiver 220, the processor 240 may first enlarge the reflected signal using an operational amplifier (not shown in figures), and then the processor 240 may compare the voltage value of the enlarged signal with a threshold using a comparator (not shown in figures) to determine whether the voltage value of the enlarged signal is greater than the threshold. If the voltage value of the enlarged signal is greater than the threshold, the processor 240 may calculate distance based on the roundtrip time of the ultrasonic signal, and transmit a response signal containing information about the distance to the control device 120. If the voltage value of the enlarged signal is not greater than the threshold, the processor 240 may restart to wait for a new control signal to be transmitted by the control device 120.

FIG. 4A is a circuit diagram illustrating an ultrasound ranging device 110 according to an embodiment of the invention. FIG. 4B is a circuit diagram illustrating a control device 120 according to an embodiment of the invention. Note that FIGS. 4A and 4B are simplified circuit diagrams illustrating an embodiment of the invention. However, the invention should not be limited to what is shown in FIGS. 4A and 4B. As shown in FIGS. 4A and 4B, the sixth pin and eighth pin of the processor 240 are respectively coupled to the second pin and third pin of the random number generator 230, the fifth pin and seventh pin of the processor 240 are coupled to the ultrasound transmitter 210, and the twelfth pin of the processor 240 is coupled to the ultrasound receiver 220. In addition, the third pin of the processor 240 is coupled to the fourth pin of control device 120, the ninth pin of the processor 240 is coupled to the third pin of control device 120, and the tenth pin of the processor 240 is coupled to the second pin of control device 120. In addition, in FIG. 4B, the processor 240 obtains the pin value Ad through its eleventh pin (ADC pin) to generate the delay time Ur. The processor 240 may read the random number Rn generated by the random number generator 230 and read the pin value Ad through its eleventh pin. Then, the processor 240 may generate a delay time Ur according to the random number Rn and the pin value Ad. The control device 120 may transmit a control signal OP_TRIGER to the processor 240 through its third pin to notify the processor 240 to perform the ultrasound ranging. When the processor 240 calculates distance based on the roundtrip time of the ultrasonic signal, the processor 240 may transmit a response signal OP_ECHO about the distance to the control device 122 through its tenth pin to notify the control device 120 about the result of the ultrasound ranging (i.e. the distance). According to an embodiment of the invention, as shown in FIG. 4A, the ADC pin may be connected to the circuit board of the ultrasound ranging device 110 by a single-ended concentric winding pattern.

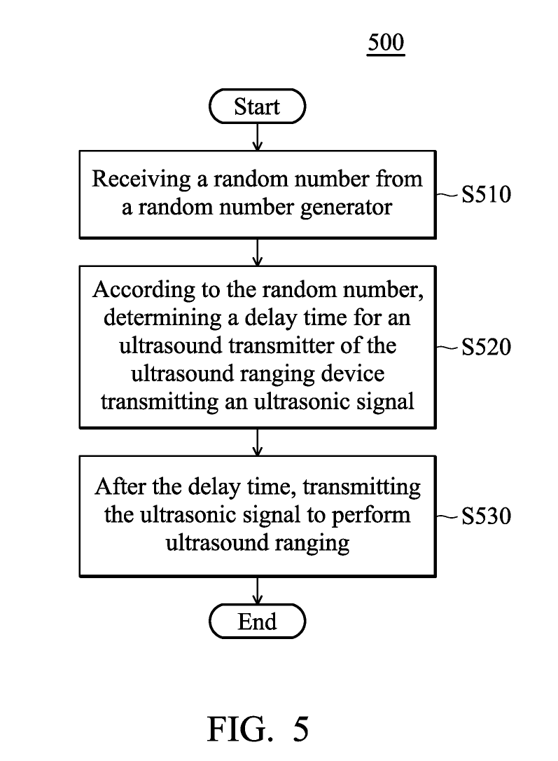

FIG. 5 is a flow chart 500 illustrating an ultrasound ranging method according to an embodiment of the invention. The ultrasound ranging method is applied to the electronic device 100 and the ultrasound ranging device 110. As shown in FIG. 5, in step S510, an ultrasound ranging device may receive a random number through a random number generator. In step S520, the ultrasound ranging device determine the delay time for an ultrasound transmitter of the ultrasound ranging device according to the random number. In step S530, after the delay time, the ultrasound transmitter of the ultrasound ranging device may transmit an ultrasonic signal to perform ultrasound ranging.

According to an embodiment of the invention, the ultrasound ranging method further comprises a processor of the ultrasound ranging device determining whether there is a control signal transmitted from a control device. When the processor of the ultrasound ranging device receives a control signal transmitted from the control device, the processor of the ultrasound ranging device may perform the above flow for ultrasound ranging according to the control signal.

According to an embodiment of the invention, in step S520, the ultrasound ranging device may perform a calculation according to the random number and the pin value corresponding to the ADC pin of the processor of the ultrasound ranging device to generate a delay time. According to an embodiment of the invention, the calculation may be an add operation, but the invention should not be limited thereto.

According to an embodiment of the invention, the ultrasound ranging method further comprises the processor of the ultrasound ranging device starting to count time after an ultrasound transmitter of the ultrasound ranging device transmits the ultrasonic signal. If the ultrasound receiver of the ultrasound ranging device does not receive the reflected signal within a default time (e.g. 5 ms), the ultrasound ranging device may restart to wait for a new control signal to be transmitted by the control device.

According to an embodiment of the invention, the ultrasound ranging method further comprises the reflected signal being enlarged by an operational amplifier after the processor of the ultrasound ranging device receives the reflected signal (which is transformed into a voltage signal by the ultrasound receiver) from the ultrasound receiver. Then, the voltage value of the enlarged signal may be compared with a threshold by a comparator to determine whether the voltage value of the enlarged signal is greater than the threshold. If the voltage value of the enlarged signal is greater than the threshold, the ultrasound ranging device may calculate distance based on the roundtrip time of the ultrasonic signal, and transmit a response signal containing information about the distance to the control device. If the voltage value of the enlarged signal is not greater than the threshold, the ultrasound ranging device may restart to await a new control signal transmitted by the control device.

According to the ultrasound ranging method provided in the embodiments of the invention, when a plurality of electronic devices need to perform ultrasound ranging, each may do so after its corresponding delay time. Therefore, when a plurality of electronic devices need to perform ultrasound ranging, interference between the electronic devices can be avoided. In addition, according to the ultrasound ranging method provided in the embodiments of the invention, electronic devices may reduce their dependence on indoor positioning or satellite positioning.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An ultrasound ranging device, comprising:
an ultrasound transmitter, transmitting an ultrasonic signal;
an ultrasound receiver, receiving a reflected signal which is generated when the ultrasonic signal meets an obstacle;
a random number generator, generating a random number; and
a processor, coupled to the random number generator to obtain the random number and according to the random number, determining a delay time for the ultrasound transmitter transmitting the ultrasonic signal,
wherein after the delay time, the ultrasound transmitter transmits the ultrasonic signal to perform ultrasound ranging.

2. The ultrasound ranging device of claim 1, wherein the processor receives a control signal from a control device to perform ultrasound ranging according to the control signal.

3. The ultrasound ranging device of claim 1, wherein the processor performs a calculation according to the random number and a pin value corresponding to a pin of the processor to generate the delay time.

4. The ultrasound ranging device of claim 2, wherein after the ultrasound transmitter transmits the ultrasonic signal, the processor starts to count time, and wherein if the ultrasound receiver does not receive the reflected signal within a default time, the processor restarts to await a new control signal transmitted by the control device.

5. The ultrasound ranging device of claim 4, wherein when the processor receives the reflected signal, the processor enlarges the reflected signal, and compares a voltage value of the enlarged signal with a threshold to determine whether the voltage value of the enlarged signal is greater than the threshold.

6. The ultrasound ranging device of claim 5, wherein if the voltage value of the enlarged signal is greater than the threshold, the processor calculates distance based on roundtrip time of the ultrasonic signal, and transmits a response signal containing information about the distance to the control device; and wherein if the voltage value of the enlarged signal is not greater than the threshold, the processor restarts to await a new control signal transmitted by the control device.

7. An electronic device, comprising:
a control device, generating a control signal; and
an ultrasound ranging device, coupled to the control device, wherein the ultrasound ranging device comprises:
an ultrasound transmitter, transmitting an ultrasonic signal;
an ultrasound receiver, receiving a reflected signal which is generated when the ultrasonic signal meets an obstacle;
a random number generator, generating a random number; and
a processor, coupled to the random number generator to obtain the random number and according to the random number, determining a delay time for the ultrasound transmitter transmitting the ultrasonic signal,
wherein after the delay time, the ultrasound transmitter transmits the ultrasonic signal to perform ultrasound ranging.

8. The electronic device of claim 7, wherein the processor receives the control signal from the control device to perform ultrasound ranging according to the control signal.

9. The ultrasound ranging system of claim 7, wherein the processor performs a calculation according to the random number and a pin value corresponding to a pin of the processor to generate the delay time.

10. An ultrasound ranging method, applied to an ultrasound ranging device, comprising:
receiving a random number from a random number generator;
according to the random number, determining a delay time for an ultrasound transmitter of the ultrasound ranging device transmitting an ultrasonic signal; and
after the delay time, transmitting the ultrasonic signal to perform ultrasound ranging.
